(19) United States
(12) Patent Application Publication
(10) Pub. No.: US 2009/0293684 A1
(43) Pub. Date: Dec. 3, 2009

(54) Aerator tool

(76) Inventors: Michael S. Hughett, Monrovia, IN (US); Jeffrey L. Moore, Frankfort, IN (US)

Correspondence Address: Douglas A. Yerkeson;Baker & Daniels LLP, 300 North Meridian Street, Suite 2700, Indianapolis, IN, 46204, US

(21) Appl. No.: 12/156,353

(22) Filed: May 30, 2008

(51) Int. Cl. B25B 13/06

(52) U.S. Cl. 81/121.1

(57) ABSTRACT

A tool to facilitate the installation and removal of a flow control member, illustratively an aerator, within a faucet spout.

### BACKGROUND AND SUMMARY OF THE INVENTION

The present invention relates generally to plumbing tools and, more particularly, to a tool configured to facilitate the installation and removal of an aerator from a faucet spout.

It is known to provide specialized tools or wrenches for the installation and removal of aerators from the water outlet of a faucet spout. Such tools are of particular benefit when the aerator is recessed within the delivery spout of the faucet, or configured to be tamper or vandal resistant.

The aerator tool of the present disclosure is configured to provide for easy insertion and removal of aerators, while facilitating storage when not in use.

According to an illustrative embodiment of the present disclosure, a plumbing tool is provided for rotationally engaging and turning a flow control fitting within a faucet spout. The plumbing tool includes a body having a longitudinal axis extending between a first end and a second end. A rotational fixing member includes a plurality of axially extending, circumferentially spaced projections supported by the first end of the body and configured to be positioned in a rotationally fixed manner with an outlet end of the flow control fitting. A translational fixing member includes an axially extending annular wall concentrically positioned relative to the longitudinal axis and supported by the first end of the body. The translational fixing member is configured to be positioned in a translationally fixed manner with the outlet end of the flow control fitting for preventing relative movement perpendicular to the longitudinal axis and for centering the rotational fixing member with the outlet end of the flow control fitting.

According to another illustrative embodiment of the present disclosure, a plumbing tool is provided for rotationally engaging and turning a flow control fitting within a faucet spout. The plumbing tool includes a body having a longitudinal axis extending between a first end and a second end. A rotational fixing member is supported by the first end of the body and is configured to engage in a rotationally fixed manner with a mating member provided on an outlet end of the flow control fitting. A retainer is supported by the body in spaced relation to the rotational fixing member and is configured to releasably couple to a faucet component remote from the faucet spout when the rotational fixing member is disengaged from the mating member of the fitting.

According to a further illustrative embodiment of the present disclosure, a plumbing tool is provided for rotationally engaging and turning an aerator within a faucet spout. The plumbing tool includes a body having longitudinal axis extending between a first end and a second end. A rotational fixing member is supported by the first end of the body and is configured to engage in a rotationally fixed manner with a mating member provided on an outlet end of the aerator. A translational fixing member is supported by the first end of the body and is configured to be positioned in a translationally fixed manner perpendicular to the longitudinal axis with the outlet end of the aerator for centering the rotational fixing member with the outlet end of the aerator. A handle is supported by the second end of the body. A retainer is supported by the body in spaced relation to the rotational fixing member and is configured to releasably couple to a faucet component when the rotational fixing member is disengaged from the aerator.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of a plumbing tool of the present disclosure configured to engage an aerator received within an outlet end of a faucet delivery spout;

FIG. 2 is a cross-sectional view of the plumbing tool of FIG. 1, showing the plumbing tool engaged with the aerator;

FIG. 3 is a perspective view showing the plumbing tool disengaged from the aerator and removably coupled to a water supply tube;

FIG. 4 is perspective view of the plumbing tool of FIG. 1;

FIG. 5 is a top plan view of the plumbing tool of FIG. 1;

FIG. 6 is a side elevational view of the plumbing tool of FIG. 1;

FIG. 7 is a front view of the plumbing tool of FIG. 1; and

FIG. 8 is a bottom plan view of the plumbing tool of FIG. 1.

### DETAILED DESCRIPTION OF THE DRAWINGS

The embodiments of the invention described herein are not intended to be exhaustive or to limit the invention to precise forms disclosed. Rather, the embodiment selected for description have been chosen to enable one skilled in the art to practice the invention.

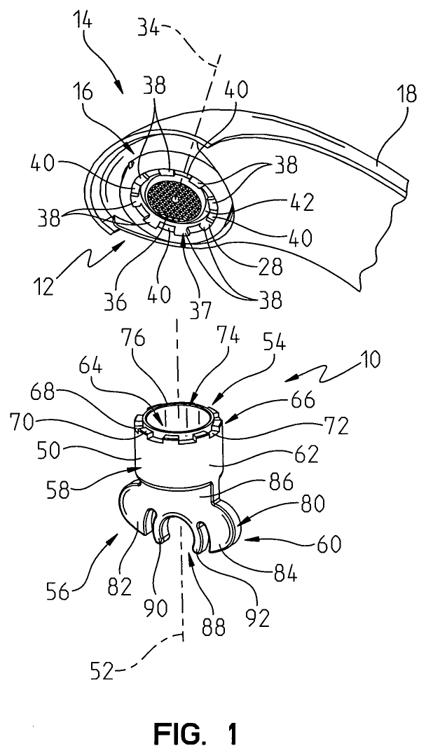

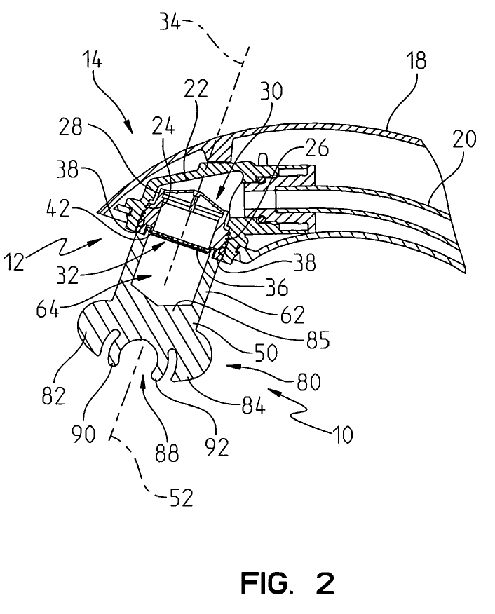

Referring initially to FIGS. 1 and 2, a plumbing tool 10 of the present disclosure is configured to facilitate the installation and removal of a flow control fitting 12 within a faucet 14. In the illustrative embodiment, the plumbing tool 10 comprises an aerator tool, and the flow control fitting 12 comprises an aerator. While the plumbing tool 10 is shown for use with the aerator 12, it should be appreciated that tool 10 may find use with other flow control fittings, such as nozzles, flow regulators, and valves. The illustrative aerator tool 10 is configured to engage and turn the aerator 12 within an outlet end 16 of a faucet delivery spout 18. The faucet 14 may be of conventional design and includes an outlet or mixed water conduit 20 received within the spout 18 and configured to deliver water from a flow control valve (not shown) to an aerator receiver or adapter 22. The receiver 22 is coupled to the outlet end 16 and the spout 18 and includes a plurality of internal threads 24 configured to threadably receive external threads 26 formed in a body 28 of the aerator 12. The aerator 12 may be of conventional design, and illustratively comprises a Caché® hidden faucet aerator available from Neoperl Inc. of Waterbury, Conn.

In the illustrative embodiment of FIGS. 1 and 2, the body 28 of the aerator 12 includes an inlet end 30 and an outlet end 32 spaced apart along a longitudinal axis 34. An outlet screen 36 is supported by the outlet end 32 of the body 28 and is centered along the longitudinal axis 34. A tool mating member 37 illustratively includes a plurality of axially outward extending projections or castles 38 that are concentrically received around the screen 36. The projections 38 are circumferentially spaced in an annular manner to define recesses 40 therebetween. The projections 38 are positioned radially outwardly from the screen 36 and in spaced relation thereto. As such, an annular groove 42 is concentrically positioned intermediate the screen 36 and the projections 38.

The aerator tool 10 includes a body 50 illustratively formed of a polymer, such as acetal, and including a longitudinal axis 52 extending between a first or receiving end 54, and a second or input end 56. The body 50 includes an engagement portion 58 and a user input portion 60. The engagement portion 58 includes a cylindrical side wall 62 concentrically disposed about the axis 52 and defining an axially inward extending socket 64. A rotational fixing member 66 illustratively includes an outer ring 68 having a plurality of projections or castles 70 extending axially outward from the first end 54 of the side wall 62. The projections 70 are circumferentially spaced to define recesses 72 therebetween. The rotational fixing member 66 is configured to engage, in a rotationally fixed manner, the mating member 37 at the outlet end 32 of the aerator 12. More particularly, the projections 70 of the tool 10 are receivable within the recesses 40 of the aerator 12 for rotational engagement with the projections 38 of the aerator 12. The projections 38 of the aerator 12 are likewise received within the recesses 72 of the tool 10.

A translational fixing member 74 is also supported by the first end 54 of the body 50. The translational fixing member 74 illustratively includes an axially extending annular wall 76 defining an inner ring 78 positioned radially inwardly from the outer ring 68 of the rotational fixing member 66. The translational fixing member 74 is configured to engage the outlet end of the aerator 12 in a translationally fixed manner to prevent relative movement perpendicular to the longitudinal axis 52 and to center the rotational fixing member 66 with the mating member 37. More particularly, the outer ring 68 is received within the groove 42 of the aerator 12 to prevent movement transverse to the longitudinal axis 52 and to properly locate the projections 70 of the tool 10 within the recesses 40 of the aerator 12.

The user input portion 60 of the aerator tool 10 includes a handle 80. More particularly, the handle 80 includes first and second spaced apart planar blades 82 and 84 coupled to a base 85 of the engagement portion 58 by a planar bridge 86. A retainer 88 is supported by the bridge 86 at the second end 56 of the body 50. The retainer 88 illustratively includes a pair of arcuate arms 90 and 92 positioned radially between the blades 82 and 84 of the handle 80. In one illustrative embodiment, the arms 90 and 92 are disposed within the same plane as the blades 82 and 84 to generally form an inner extension of the handle 80.

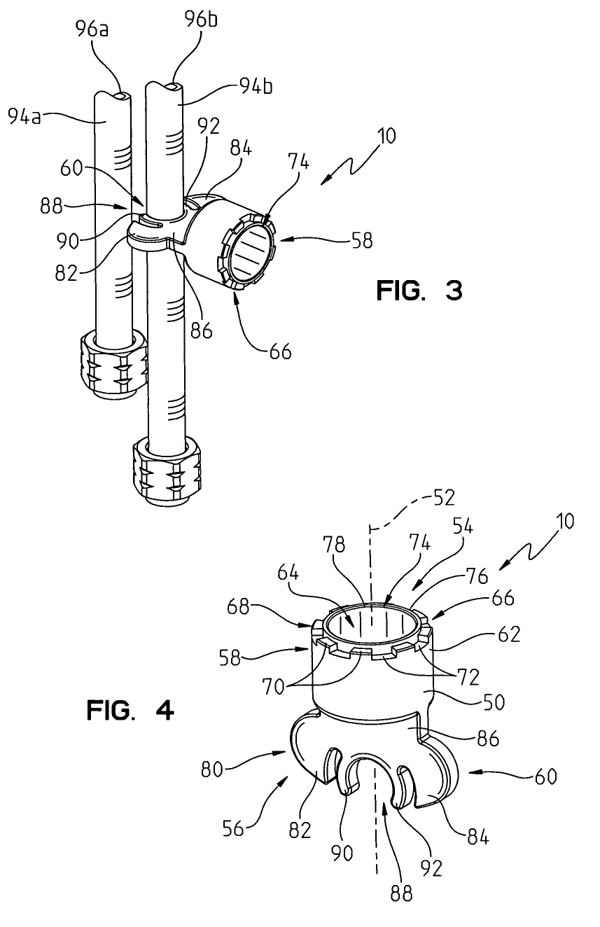

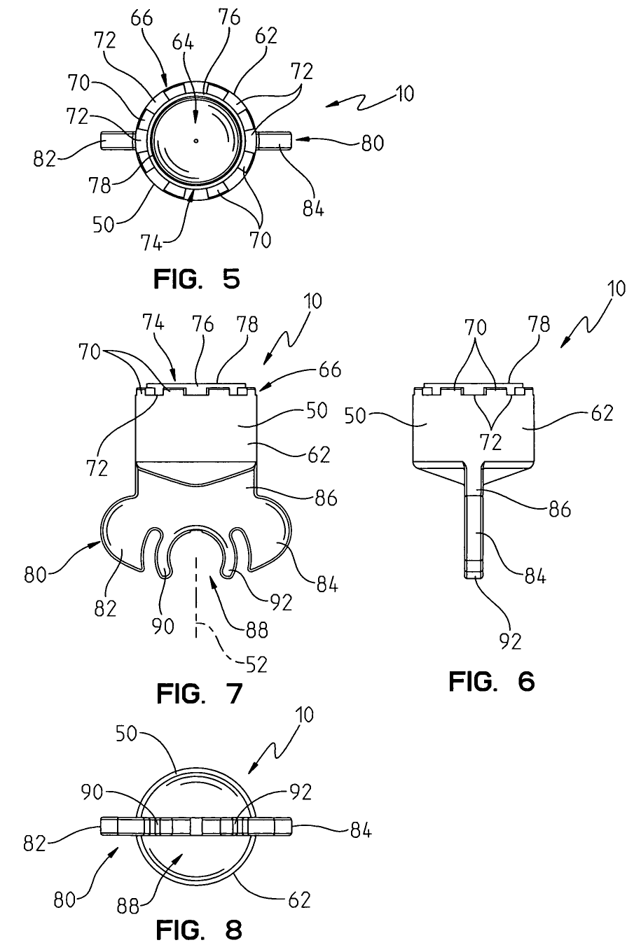

As shown in FIG. 3, the arcuate arms 90 and 92 are configured to releasably engage or snap about a conventional faucet component, illustratively a fluid conduit or supply tube 94. In the illustrative embodiment, the tube 94a supplies hot water to the faucet 14, while the tube 94b supplies cold water to the faucet 14. The tubes 94 each include a resilient side wall 96a, 96b, illustratively a polymer, such as a cross-linked polyethylene (PEX).

In operation, the user generally aligns the receiving or first end 54 of the aerator tool 10 with the outlet end 32 of the aerator 12. The inner ring 78 assists in properly locating the projections 70 of the outer engagement ring 68 with the recesses 40 of the aerator 12. Furthermore, the inner ring 78 facilitates in the insertion, removal, and operation of the aerator tool 10 without slipping. Engagement between the projections 70 and 38 of the aerator tool 10 and the aerator 12, respectively, facilitate rotational movement of the aerator 12 in response to rotation imparted to the aerator tool 10 by the user turning the handle 80. Rotation of the aerator 12 in clockwise and counterclockwise directions cause the aerator 12 to thread and unthread, respectively, from the receiver 22 of the spout 18.

Once the user has completed use of the aerator tool 10 and it has been disengaged from the aerator 12, he or she may store the tool 10 by clipping it to the one of the supply tubes 94a, 94b of the faucet 14. More particularly, the user merely pushes the tool 10 in a direction perpendicular to the axis of the respective tube 94 such that the arcuate arms 90 and 92 move over the side wall 96 of the tube 94 and are snapped into place.

Although the invention has been described in detail with reference to certain preferred embodiments, variations and modifications exist within the spirit and scope of the invention as described and defined in the following claims.

1. A plumbing tool for rotationally engaging and turning a flow control fitting within a faucet spout, the tool comprising:
a body including longitudinal axis extending between a first end and a second end;
a rotational fixing member including a plurality of axially extending, circumferentially spaced projections supported by the first end of the body and configured to be positioned in a rotationally fixed manner with the outlet end of the flow control fitting; and
a translational fixing member including an axially extending annular wall concentrically positioned relative to the longitudinal axis and supported by the first end of the body, the translational fixing member configured to be positioned in a translationally fixed manner with the outlet end of the flow control fitting for preventing relative movement perpendicular to the longitudinal axis and for centering the rotational fixing member with the outlet end of the flow control fitting.

2. The plumbing tool of claim 1, wherein the annular wall is positioned radially inwardly from the plurality of axially extending, circumferentially spaced projections.

3. The plumbing tool of claim 1, further comprising a retainer supported by the body and configured to releasably couple to a faucet component.

4. The plumbing tool of claim 3, wherein the retainer comprises a clip including a pair of arcuate arms configured to releasably couple to a tube.

5. The plumbing tool of claim 4, further comprising a handle supported by the second end of the body, the handle including a pair of blades positioned radially outwardly from the arcuate arms of the clip.

6. The plumbing tool of claim 1, wherein the body includes a cylindrical side wall defining a socket extending axially inward from the first end, the plurality of axially extending, circumferentially spaced projections being positioned radially outwardly from the socket and concentrically disposed relative to the socket, and the annular wall being positioned intermediate the socket and the plurality of axially extending circumferentially spaced projections.

7. A plumbing tool for rotationally engaging and turning a flow control fitting within a faucet spout, the tool comprising:
a body including longitudinal axis extending between a first end and a second end;
a rotational fixing member supported by the first end of the body and configured to engage in a rotationally fixed manner with a mating member provided on an outlet end of the flow control fitting; and
a retainer supported by the body in spaced relation to the rotational fixing member and configured to releasably couple to a faucet component remote from the faucet spout when the rotational fixing member is disengaged from the mating member of the fitting.

8. The plumbing tool of claim 7, further comprising a translational fixing member supported by the first end and configured to be positioned in a translationally fixed manner perpendicular to the longitudinal axis with the outlet end of the flow control fitting for centering the rotational fixing member with the mating member of the outlet end of the flow control fitting.

9. The plumbing tool of claim 8, wherein the translational fixing member comprises an axially extending annular wall concentrically positioned relative to the longitudinal axis.

10. The plumbing tool of claim 8, wherein the body includes a cylindrical side wall defining a socket extending axially inward from the first end, the rotational fixing member is positioned radially outwardly from the socket and concentrically disposed relative to the socket, and the translational fixing member is positioned intermediate the socket and the rotational fixing member and concentrically disposed relative to the rotational fixing member.

11. The plumbing tool of claim 7, wherein the rotational fixing member comprises a plurality of axially extending, circumferentially spaced projections.

12. The plumbing tool of claim 7, wherein the retainer comprises a clip including a pair of arcuate arms, the faucet component comprises a tube, and the arcuate arms are configured to releasably couple to the tube.

13. The plumbing tool of claim 12, further comprising a handle supported by the second end of the body, the handle including a pair of blades positioned radially outwardly from the arcuate arms of the clip.

14. The plumbing tool of claim 13, wherein the blades of the handle and the arms of the clip are positioned within a plane extending along the longitudinal axis.

15. A plumbing tool for rotationally engaging and turning an aerator within a faucet spout, the tool comprising:
a body including longitudinal axis extending between a first end and a second end;
a rotational fixing member supported by the first end of the body and configured to engage in a rotationally fixed manner with a mating member provided on an outlet end of the aerator;
a translational fixing member supported by the first end of the body and configured to be positioned in a translationally fixed manner perpendicular to the longitudinal axis with the outlet end of the aerator for centering the rotational fixing member with the outlet end of the aerator;
a handle supported by the second end of the body; and
a retainer supported by the body in spaced relation to the rotational fixing member and configured to releasably couple to a faucet component when the rotational fixing member is disengaged from the aerator.

16. The plumbing tool of claim 15, wherein the rotational fixing member comprises a plurality of axially extending, circumferentially spaced projections.

17. The plumbing tool of claim 16, wherein the translational fixing member comprises an axially extending annular wall concentrically positioned relative to the rotational fixing member.

18. The plumbing tool of claim 17, wherein the retainer comprises a clip including a pair of arcuate arms, the faucet component comprises a tube, and the arcuate arms are configured to releasably couple to the tube.

19. The plumbing tool of claim 18, wherein the handle including a pair of blades positioned radially outwardly from the arcuate arms of the clip.

20. The plumbing tool of claim 19, wherein the blades of the handle and the arms of the clip are positioned within a plane extending along the longitudinal axis.
